(19) United States
(12) Patent Application Publication
(10) Pub. No.: US 2024/0301174 A1
(43) Pub. Date: Sep. 12, 2024

(54) COMPOSITIONS AND METHODS FOR IMPROVING THE MELT PROCESSING OF A POLYKETONE POLYMER SUITABLE FOR DIRECT OR INDIRECT CONTACT WITH FOOD

(71) Applicant: PolySource LLC, Overland Park, KS (US)

(72) Inventors: Johnson C. Watkins, Newark, DE (US); Jeremy Bland, Waukee, IA (US); Adam Bannerman, Mandeville, LA (US); Stephen O'Connor, Dedham, MA (US)

(73) Assignee: PolySource LLC, Overland Park, KS (US)

(21) Appl. No.: 18/599,063

(22) Filed: Mar. 7, 2024

Related U.S. Application Data
(60) Provisional application No. 63/450,631, filed on Mar. 7, 2023.

(51) Int. Cl. C08K 9/06; C08K 3/22; C08L 73/00

(52) U.S. Cl. CPC C08K 9/06; C08K 3/22; C08L 73/00; C08K 2003/2224; C08K 2201/005; C08L 2201/02

(57) ABSTRACT

The present disclosure is directed to self-extinguishing aliphatic polyketone compositions suitable for direct or indirect contact with food and method of preparing same. The compositions and methods demonstrate an inverse synergistic effect between the composition's melt viscosity and a minimum amount of magnesium hydroxide to provide the composition with a self-extinguishing performance.

### CROSS-REFERENCE TO RELATED APPLICATIONS

This application claims the benefit of U.S. Provisional Application No. 63/450,631, filed Mar. 7, 2023, the disclosure of which is hereby expressly incorporated by reference herein in its entirety.

### FIELD OF THE DISCLOSURE

Embodiments of the instant disclosure generally relate to compositions and methods for improving self-extinguishing properties, maintaining mechanical properties, and improving the melt processing of a polyketone polymer suitable for direct or indirect contact with food.

### BACKGROUND OF THE INVENTION

Self-extinguishing (SE) thermoplastic materials suitable for direct and indirect contact with food, are limited to polymers which are inherently self-extinguishing also referred to as flame retardant materials or plastics or resins. These inherently SE materials are comprised of PPS (polyphenylene sulfide) and PEEK (polyether ether ketone) based semi crystalline resins and PES (polyethersulfone), PEI (polyether imide) and PPSU (polyphenylsulfone) amorphous resins, as well as a subset of PC (polycarbonate) materials. All of these materials require design and/or end use compromises in chemical resistance or melt processing or cost per cubic inch, thereby limiting the use of these materials for food contact end uses.

Non-self-extinguishing polymers such as polypropylene or PBT (polybutylene terephthalate) polyester, require the use of flame retardant additive technologies ranging from brominated chemicals or polymers and antimony synergists, metal phosphonates, melamine polyphosphate or elemental phosphorus. None of these polymers are deemed safe for contact with food.

Traditional flame retardants additives such as magnesium-based hydroxides (Mg(OH)₂) and aluminum based hydroxides (Al(OH)₃) are widely used in polymer matrices as an additive to fabricate engineered materials, such as cross-linked polymer compounds and thermoplastics (polypropylene and polyethylene). It is known that the use of surface treatments such as silanes, titanates, zirconates and the like, promote adhesion and compatibilization of the metal hydroxide within the polymer matrix, as well. Enhancing compatibilization in the matrix leads to improved mechanical performance of the mixture. These additives are considered environmentally friendly. A subset of these metal hydroxide additives is deemed safe for food contact; however, the weight percent loading in the polymer blend is so large that mechanical properties of components molded or formed from such a blend are too low for most end use applications in food manufacturing.

Upon contact with an activation temperature of about 250° C., the magnesium-based hydroxides decompose liberating MgO and releasing water as vapor. The MgO provides a stable oxide protective film which provides good fire resistance, prevents oxygen from participating in the combustion process, and eliminates a portion of the heat transfer in the combustion process. The water vapor provides a reduction of the combustion of the polymers (cross-linked polymer compounds and thermoplastics) in gas phase. Aluminum-based hydroxides work similar to magnesium-based hydroxides but require a lower activation temperature.

What is needed is a transformation of a non-SE polymer aliphatic polyketone (POK) into a material that readily self-extinguishes, retains a high percentage of the base polymer's mechanical properties, is suitable for direct contact with food, remains highly chemically resistant to commercial grade sterilizing chemicals and can be melt processed in existing tooling.

### SUMMARY OF THE INVENTION

Embodiments of the present disclosure relate to self-extinguishing aliphatic polyketone compositions suitable for direct or indirect contact with food. In some embodiments, the present disclosure encompasses a self-extinguishing aliphatic polyketone composition, the composition comprising about 80.0 wt. % to about 95.0 wt. % of an aliphatic polyketone polymer resin and from about 5.0 wt. % to about 20.0 wt. % of an amino silane surface modified magnesium hydroxide.

In certain embodiments, the present disclosure encompasses a method of preparing a self-extinguishing aliphatic polyketone composition suitable for direct or indirect contact with food, the method comprising: combining a aliphatic polyketone polymer resin and an amino silane surface modified magnesium hydroxide to form a mixture; melting the mixture; and forming the self-extinguishing aliphatic polyketone composition. The use of a silane treated magnesium hydroxide boost mechanical performance but is not required, for this invention.

Other features and iterations of the invention are described in more detail below.

### DETAILED DESCRIPTION OF THE INVENTION

In the following sections, certain exemplary compositions and methods are described to detail certain embodiments of this invention. It will be obvious to one skilled in the art that practicing the certain embodiments does not require the employment of all or even some of the specific details outlined herein, but rather that concentrations, times, and other specific details can be modified through routine experimentation. In some cases, well known methods or components have not been included in the description.

The present disclosure is based on the discovery that an inverse synergistic effect exists between the composition's melt viscosity and a minimum amount of magnesium hydroxide to provide the composition with a self-extinguishing performance.

Process aids such as, mold release additives, heat stabilizers and lubricants, may further enhance the magnesium hydroxide polyketone mixture for injection molding and profile extrusion of finished articles, without adversely effecting self-extinguishing nor food contact compatibility.

Mold release and lubricant additives include fatty amides such as erucamides, montan waxes, and paraffin waxes may be effective to reduce frictional heat that may arise in melt processing. Avoiding excessive heating of the polymer melt minimizes color changes in the plastic, minimizes formation of black specks and other thermal decomposition species as well as increases overall process output.

Low density and linear low density polyethylene (LLDP) while higher in molecular weight than paraffin waxes, may also be used in very low concentrations to lubricate the molten polymer mixture to enhance processability.

### I. Compositions

The present disclosure relates to a self-extinguishing aliphatic polyketone composition suitable for direct or indirect contact with food. The self-extinguishing aliphatic polyketone composition demonstrates an inverse synergistic effect between the composition's melt viscosity and a minimum amount of amino silane modified magnesium hydroxide to provide the composition with self-extinguishing performance.

### Aliphatic Polyketone Resins

The composition includes an aliphatic polyketone resin. Aliphatic polyketone polymers are a family of high-performance thermoplastic polymers and prepared as copolymers and terpolymers. The polar ketone groups in the resin provide the polymer backbone of these materials a strong attraction between polymer chains, either ionic and/or Van der Walls interactions. With this strong interaction, the material's melting point (255° C. for copolymer (carbon monoxide and ethylene), 220° C. for terpolymer (carbon monoxide, ethylene, and propylene). A small fraction of the ethylene is generally replaced with propylene to reduce the melting point somewhat.

Generally, the weight % (wt. %) of the aliphatic polyketone polymer resin in the composition may be about 80.0 wt. % to about 95.0 wt. % of the total weight of the composition. In various embodiments, the wt. % of the aliphatic polyketone polymer resin in the composition may be about 80.0 wt. % to about 95.0 wt. %, about 80.0 wt. %, about 81.0 wt. %, about 82.0 wt. %, about 83.0 wt. %, about 84.0 wt. %, about 85.0 wt. %, about 86.0 wt. %, about 87.0 wt. %, about 88.0 wt. %, about 89.0 wt. %, about 90.0 wt. %, about 91.0 wt. %, about 92.0 wt. %, about 93.0 wt. %, about 94.0 wt. %, about 95.0 wt. %, from about 80.0 wt. % to about 82.5 wt. %, from about 82.5 wt. % to about 85.0 wt. %, from about 85.0 wt. % to about 87.5 wt. %, from about 87.5 wt. % to about 90.0 wt. %, from about 90.0 wt. % to about 92.5 wt. %, from about 92.5 wt. % to about 95.0 wt. %, from about 81.0 wt. % to about 83.0 wt. %, from about 83.0 wt. % to about 85.0 wt. %, from about 85.0 wt. % to about 87.0 wt. %, from about 87.0 wt. % to about 89.0 wt. %, from about 89.0 wt. % to about 91.0 wt. %, from about 91.0 wt. % to about 93.0 wt. %, or from about 93.0 wt. % to about 95.0 wt. % of the total weight of the composition.

The aliphatic polyketone polymer resin may comprise a low molecular weight aliphatic polyketone polymer resin and a high molecular weight polyketone polymer resin such as Poketone® M330 F and Poketone® M630 F produced by Hyosung Chemical Corporation. Generally, higher amounts of the high molecular weight polymer resins provide more desirable mechanical attributes such as mechanical strength, impact resistance, etc. in the final mixture, and concomitantly lower weight % of magnesium hydroxide. It is known to those skilled in the art, that as polymer molecular weight increases, so too, melt viscosity increases. Likewise, as polymer molecular weight decreases, melt viscosity decreases.

In general, the aliphatic polyketone polymer resin comprises from about 75.0 wt. % to about 100.0 wt. % of a high molecular weight aliphatic polyketone polymer resin and from about 0.0 wt. % to about 25.0 wt. % of a low molecular weight aliphatic polyketone resin. In various embodiments, the aliphatic polyketone polymer resin comprises from about 75.0 wt. % to about 100.0 wt. % of a high molecular weight aliphatic polyketone polymer resin, about 75.0 wt. %, about 76.0 wt. %, about 77.0 wt. %, about 78.0 wt. %, about 79.0 wt. %, about 80.0 wt. %, about 81.0 wt. %, about 82.0 wt. %, about 83.0 wt. %, about 84.0 wt. %, about 85.0 wt. %, about 86.0 wt. %, about 87.0 wt. %, about 88.0 wt. %, about 89.0 wt. %, about 90.0 wt. %, about 91.0 wt. %, about 92.0 wt. %, about 93.0 wt. %, about 94.0 wt. %, about 95.0 wt. %, about 96.0 wt. %, about 97.0 wt. %, about 98.0 wt. %, about 99.0 wt. %, about 100.0 wt. %, from about 75.0 wt. % to about 80.0 wt. %, from about 80.0 wt. % to about 85.0 wt. %, from about 85.0 wt. % to about 90.0 wt. %, from about 90.0 wt. % to about 95.0 wt. %, or from about 95.0 wt. % to about 100.0 wt. % of the high molecular weight aliphatic polyketone polymer resin and from about 0.0 wt. % to about 25.0 wt. %, about 0.0 wt. %, about 1.0 wt. %, about 2.0 wt. %, about 3.0 wt. %, about 4.0 wt. %, about 5.0 wt. %, about 6.0 wt. %, about 7.0 wt. %, about 8.0 wt. %, about 9.0 wt. %, about 10.0 wt. %, about 11.0 wt. %, about 12.0 wt. %, about 13.0 wt. %, about 14.0 wt. %, about 15.0 wt. %, about 16.0 wt. %, about 17.0 wt. %, about 18.0 wt. %, about 19.0 wt. %, about 20.0 wt. %, about 21.0 wt. %, about 22.0 wt. %, about 23.0 wt. %, about 24.0 wt. %, about 25.0 wt. %, from about 0.0 wt. % to about 5.0 wt. %, from about 5.0 wt. % to about 10.0 wt. %, from about 10.0 wt. % to about 15.0 wt. %, from about 15.0 wt. % to about 20.0 wt. %, or from about 20.0 wt. % to about 25.0 wt. % of the low molecular weight aliphatic polyketone polymer resin.

### Amino Silane Modified Magnesium Hydroxide

The composition further includes an amino silane modified magnesium hydroxide. Other metal hydroxides such as non-surface treated magnesium hydroxide or aluminum hydroxides are well known. These materials act as a flame retardants and smoke suppressors in plastics mainly by withdrawing heat from the plastic during its decomposition into magnesium oxide or aluminum oxide and water. The water vapor generated from the decomposition dilutes the supply of fuel to the flame.

The amino silane modified magnesium hydroxide produced by Huber Materials has an average particle size of about 1.5 microns.

Generally, the amino silane modified magnesium hydroxide comprises from about 5.0 wt. % to about 20.0 wt. % of the total weight of the composition. In various embodiments, the amino silane modified magnesium hydroxide comprises from about 5.0 wt. % to about 20.0 wt. %, about 5.0 wt. %, about 6.0 wt. %, about 7.0 wt. %, about 8.0 wt. %, about 9.0 wt. %, about 10.0 wt. %, about 11.0 wt. %, about 12.0 wt. %, about 13.0 wt. %, about 14.0 wt. %, about 15.0 wt. %, about 16.0 wt. %, about 17.0 wt. %, about 18.0 wt. %, about 19.0 wt. %, about 20.0 wt. %, from about 5.0 wt. % to about 10.0 wt. %, from about 10.0 wt. % to about 15.0 wt. %, or from about 15.0 wt. % to about 20.0 wt. % of the total weight of the composition.

### Other Components

The composition may further include one or more additional components, including dispersing agent or lubricant, antioxidant, polyamide, thermoplastic polyurethane (TPU), antioxidant stabilizer, linear low density polyethylene (LLDPE), white pigment, or a combination thereof.

An example of a suitable dispersing agent or lubricant includes but is not limited to N,N′-ethylenebis(stearamide) (Struktol®TR EBS or Struktol®TR EBS VG) or erucamide (Struktol®TR-131). The dispersing agent or lubricant may be present in an amount from about 0 wt. % to about 1.0 wt. % of the total weight of the composition. In some embodiments, the dispersing agent or lubricant comprises about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, or about 1.0 wt. % of the total weight of the composition.

An example of a suitable antioxidant stabilizer includes but is not limited to Irganox 1010. The antioxidant stabilizer may be present in an amount from about 0 wt. % to about 1.0 wt. % of the total weight of the composition. In some embodiments, the antioxidant stabilizer comprises about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, or about 1.0 wt. % of the total weight of the composition.

An example of a suitable LLDPE includes but is not limited to HIVAL PE LLD 102024. The LLDPE may be present in an amount from about 0 wt. % to about 5.0 wt. % of the total weight of the composition. In some embodiments, the antioxidant stabilizer comprises about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2.0 wt. %, about 2.1 wt. %, about 2.2 wt. %, about 2.3 wt. %, about 2.4 wt. %, about 2.5 wt. %, about 2.6 wt. %, about 2.7 wt. %, about 2.8 wt. %, about 2.9 wt. %, about 3.0 wt. %, about 3.1 wt. %, about 3.2 wt. %, about 3.3 wt. %, about 3.4 wt. %, about 3.5 wt. %, about 3.6 wt. %, about 3.7 wt. %, about 3.8 wt. %, about 3.9 wt. %, about 4.0 wt. %, about 4.1 wt. %, about 4.2 wt. %, about 4.3 wt. %, about 4.4 wt. %, about 4.5 wt. %, about 4.6 wt. %, about 4.7 wt. %, about 4.8 wt. %, about 4.9 wt. %, or about 5.0 wt. % of the total weight of the composition.

An example of a suitable polyamide includes but is not limited to Ultramid B27. The LLDPE may be present in an amount from about 0 wt. % to about 20.0 wt. % of the total weight of the composition. In some embodiments, the polyamide comprises about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, or about 20 wt. % of the total weight of the composition.

An example of a suitable thermoplastic polyurethane includes but is not limited to Laripur 5725. The TPU may be present in an amount from about 0 wt. % to about 20.0 wt. % of the total weight of the composition. In some embodiments, the polyamide comprises about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, or about 20 wt. % of the total weight of the composition.

The white pigment may be present in an amount from about 0 wt. % to about 2 wt. % of the total weight of the composition. In some embodiments, the white pigment comprises about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, or about 2.0 wt. % of the total weight of the composition.

Properties of the Self-Extinguishing Aliphatic Polyketone Composition Suitable for Direct or Indirect Contact with Food

The self-extinguishing aliphatic polyketone composition suitable for direct or indirect contact with food has some distinctive properties.

The composition comprises a plastic flammability standard of V-2 performance measured by UL-94 3 mm test.

The composition may further comprise a tensile strength ranging from about 9,200 pounds per square inch (psi) to about 9,700 psi. In various embodiments, the composition comprises a tensile strength ranging from about 9,200 pounds per square inch (psi) to about 9,700 psi, about 9,200 psi, about 9,250 psi, about 9,300 psi, about 9,350 psi, about 9,400 psi, about 9,450 psi, about 9,500 psi, about 9,550 psi, about 9,600 psi, about 9,650 psi, about 9,700 psi, from about 9,200 psi to about 9,300 psi, from about 9,300 psi to about 9,400 psi, from about 9,400 psi to about 9,500 psi, from about 9,500 psi to about 9,600 psi, or from about 9,600 psi to about 9,700 psi.

The composition may further comprise a tensile strength ranging from about 50 MPa to about 70 MPa. In various embodiments, the composition comprises a tensile strength ranging from about 51 MPa to about 69 MPa, about 52 MPa to about 68 MPa, about 53 MPa to about 67 MPa, about 54 MPa to about 66 MPa, about 55 MPa to about 65 MPa, about 56 MPa to about 64 MPa, about 57 MPa to about 63 MPa, about 58 MPa to about 62 MPa, or about 59 MPa to about 61 MPa. In some preferred embodiments, the tensile strength may be about 55.0 MPa, about 55.1 MPa, about 55.2 MPa, about 55.3 MPa, about 55.3 MPa, about 55.4 MPa, about 55.5 MPa, about 55.6 MPa, about 55.7 MPa, about 55.8 MPa, about 55.9 MPa, about 56.0 MPa, about 56.1 MPa, about 56.2 MPa, about 56.3 MPa, about 56.3 MPa, about 56.4 MPa, about 56.5 MPa, about 56.6 MPa, about 56.7 MPa, about 56.8 MPa, about 56.9 MPa, 57.0 MPa, about 57.1 MPa, about 57.2 MPa, about 57.3 MPa, about 57.3 MPa, about 57.4 MPa, about 57.5 MPa, about 57.6 MPa, about 57.7 MPa, about 57.8 MPa, about 57.9 MPa, or about 58 MPa.

The composition may further comprise an elongation (or a tensile elongation) at break ranging from about 25% to about 60%. For example the elongation at break may be about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%. In some preferred embodiments, the elongation at break may range from about 27% to about 31%.

The composition has a tensile modulus ranging from 360,000 psi to about 370,000 psi. In various embodiments, the composition has a tensile modulus of about 360,000 psi, about 361,000 psi, about 362,000 psi, about 363,000 psi, about 364,000 psi, about 365,000 psi, about 366,000 psi, about 367,000 psi, about 368,000 psi, about 369,000 psi, or about 370,000 psi.

The composition has a tensile modulus ranging from 1.80 GPa to about 2.00 GPa. In various embodiments, the composition has a tensile modulus of about 1.80 GPa, about 1.81 GPa, about 1.82 GPa, about 1.83 GPa, about 1.84 GPa, about 1.85 GPa, about 1.86 GPa, about 1.87 GPa, about 1.88 GPa, about 1.89 GPa, about 1.90 GPa, about 1.91 GPa, about 1.92 GPa, about 1.93 GPa, about 1.94 GPa, about 1.95 GPa, about 1.96 GPa, about 1.97 GPa, about 1.98 GPa, or about 2.00 GPa,

The composition comprises a notched Izod impact test ranging from about 1.60 ft-lb/in to 1.80 ft-lb/in. In various embodiments, the composition comprises a notched Izod impact test ranging from about 1.60 ft-lb/in to 1.80 ft-lb/in, about 1.60 ft-lb/in, about 1.62 ft-lb/in, about 1.64 ft-lb/in, about 1.66 ft-lb/in, about 1.68 ft-lb/in, about 1.70 ft-lb/in, about 1.72 ft-lb/in, about 1.74 ft-lb/in, about 1.76 ft-lb/in, about 1.78 ft-lb/in, about 1.80 ft-Ib/in, from about 1.60 ft-lb/in to 1.65 ft-lb/in, from about 1.65 ft-lb/in to 1.70 ft-lb/in, from about 1.70 ft-lb/in to 1.75 ft-lb/in, or from about 1.75 ft-lb/in to 1.80 ft-lb/in. *these are illustrative values only, not optimized.

The composition comprises a notched Izod impact test ranging from about 7.0 KJ/m² to about 10.0 KJ/m². In various embodiments, the composition comprises a notched Izod impact test ranging from about 7.5 KJ/m² to about 9.5 KJ/m², from about 8.0 KJ/m² to about 9.0 KJ/m², or from about 8.2 KJ/m² to about 8.5 KJ/m².

The composition comprises a notched charpy ranging from about 4.0 KJ/m² to about 10.0 KJ/m². In various embodiments, the composition comprises a notched charpy impact test ranging from about 4.1 KJ/m² to about 7.9 KJ/m², about 4.2 KJ/m² to about 7.8 KJ/m², about 4.3 KJ/m² to about 7.7 KJ/m², about 4.4 KJ/m² to about 7.6 KJ/m², about 4.5 KJ/m² to about 7.5 KJ/m², about 4.6 KJ/m² to about 7.4 KJ/m², about 4.7 KJ/m² to about 7.3 KJ/m², about 4.8 KJ/m² to about 7.2 KJ/m², about 4.9 KJ/m² to about 7.1 KJ/m², about 5.0 KJ/m² to about 7.0 KJ/m², 5.1 KJ/m² to about 6.9 KJ/m², about 5.2 KJ/m² to about 6.8 kJ/m², about 5.3 KJ/m² to about 6.7 KJ/m², about 5.4 KJ/m² to about 6.6 kJ/m², about 5.5 KJ/m² to about 6.5 KJ/m², about 5.6 KJ/m² to about 6.4 KJ/m², about 5.7 KJ/m² to about 6.3 KJ/m², about 5.8 KJ/m² to about 6.2 KJ/m², or about 4.9 KJ/m² to about 6.1 KJ/m².

The composition may further comprise a specific gravity ranging from about 1.28 to about 1.36. In various embodiments, the composition comprises a specific gravity ranging from about 1.28 to about 1.36, from about 1.28 to about 1.30, from about 1.30 to about 1.32, from about 1.32 to about 1.34, or from about 1.34 to about 1.36. For example, the specific gravity may be about 1.28, about 1.29, about 1.30, about 1.31, about 1.32, about 1.33, about 1.34, about 1.35, or about 1.36. Specific gravity enables direct measure of magnesium hydroxide content and cross-checks with thermal analysis (% ash).

The composition may further comprise an ash content ranging from about 7.0% to about 18.0% after the composition is heated to about 500° C. or greater to burn off the polyketone polymer from the composition. In various embodiments, the composition comprises an adjusted ash content ranging from about 7.0% to about 18.0%, about 7.0%, about 8.0%, about 9.0%, about 10.0%, about 11.0%, about 12.0%, about 13.0%, about 14.0%, about 15.0%, about 16.0%, about 17.0%, or about 18.0% after the composition is heated to about 500° C. or greater to burn off the polyketone polymer from the composition. The ash residue after pyrolysis is comprised of MgO with a molar mass of 40.32. The results are adjusted by 1 factor of 1.446 to report the ash as theoretical molar mass of magnesium hydroxide of 58.32.

The composition exhibits an inverse synergistic effect between the composition's melt viscosity and a minimum amount of amino silane surface modified magnesium hydroxide magnesium hydroxide to provide the composition with a self-extinguishing performance.*This synergistic effect was a complete surprise.

The composition exhibits a high chemical resistance to commercial grade sterilizing chemicals (such as bleach) and can be melt processed in existing tooling.

In some embodiments, extrusion compounded mixtures of polyketone and magnesium hydroxide may yield self-extinguishing flame resistance with magnesium hydroxide levels greater than 13% by weight and less than 14.9%, when the polyketone is 6 melt or with a blend of 6 and 60 melt flow resins. Specifically, the ratio of the 2 polymer types in a blend, may be at least 10% by weight 6 melt flow polymer and not more than 90% by weight 60 melt flow polyketone polymer.

### II. Method of Preparing a Self-Extinguishing Aliphatic Polyketone Composition

In another aspect of the present disclosure encompasses a method of preparing a self-extinguishing aliphatic polyketone composition suitable for direct or indirect contact with food. The method comprises the steps of: combining the aliphatic polyketone polymer resin and the amino silane surface modified magnesium hydroxide to form a mixture; melting the mixture; and forming the self-extinguishing aliphatic polyketone composition. The methods, as disclosed herein, may be conducted in a batch process, a semi-batch process, a semi-continuous process, or a continuous process. The methods may be conducted under an inert atmosphere and are not necessarily required to prepare the composition.

### Combining the Aliphatic Polyketone Polymer Resin and the Amino Silane Surface Modified Magnesium Hydroxide to Form a Mixture

The first step in the method comprises combining the aliphatic polyketone polymer resin and the amino silane surface modified magnesium hydroxide to form a mixture.

### Aliphatic Polyketone Polymer Resin and Amino Silane Surface Modified Magnesium Hydroxide.

The aliphatic polyketone polymer resin and the amino silane modified magnesium hydroxide are described in more detail above in Section (I). In one embodiment, the aliphatic polyketone polymer resin comprises a high molecular weight aliphatic polyketone polymer resin. In another embodiment, the aliphatic polyketone polymer resin comprises a high molecular weight aliphatic and a low molecular weight polyketone polymer resin.

The melting and mixing process to form the polyketone and magnesium hydroxide blend utilizes a continuous compounding twin screw extruder, a method known to those skilled in the art, whereby polymer pellets are fed into the back end of the extruder using gravimetric weigh scale feeding equipment, melted and conveyed forward. Magnesium hydroxide powder is fed into the extruder at a downstream port using gravimetric weigh scale feeding equipment and added to completely melted polymer. This method allows for the final composition to be mixed, metered and controlled in a continuous process. The molten mixtures exit the extruder through a die comprised of multiple openings. The extrudate, now in cylindrical form is cooled and conveyed to chopping equipment which cuts the now cool strands into cubes or pellets. The pellets are packaged for further use. Other mixing methods, for combining additives and thermoplastic melt processable polymers, are incorporated by reference.

### Melting the Mixture

The next step in the method comprises melting the mixture. The purpose of melting the mixture is to obtain a mixture having an acceptable flow rate through a commercial injection process. An acceptable flow rate designates that an adequate amount of the melted mixture can be melted, injected, used economically through the commercial injection molding machine.

The temperature of the melting of the mixture can and will vary depending on the amount of the high molecular weight aliphatic polyketone polymer resin, the low molecular weight polyketone polymer resin, and the amine amino silane surface modified magnesium hydroxide. Using larger amounts of the high molecular weight aliphatic polyketone polymer resin, the flow rate is less and termed “a viscous flow.” When larger quantities of the low molecular weight polyketone polymer resin, the flow rate is greater and termed “easy to process.”

The temperature of melting the mixture ranges from about 200° C. to about 270° C. In various embodiments, the temperature of melting the mixture ranges from about 200° C. to about 270° C., from about 210° C. to about 260° C., from about 220° C. to about 250° C. or from about 235° C. to about 245° C. In one embodiment, the temperature of melting is about 240° C.

A variety of commercial injection molding equipment is known in the art. Suitable commercial injection equipment may be a batch commercial injection equipment or a continuous commercial injection equipment. Pellets or cubes of the mixture are fed into the injection molding equipment where it is melted and injected into molds, to form finished or semi-finished articles.

### Definitions

Unless defined otherwise, all technical and scientific terms used herein have the meaning commonly understood by a person skilled in the art to which this invention belongs.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

Reference throughout this specification to “one embodiment,” “some embodiments”, “certain embodiments,” “one or more embodiments,” or “an embodiment” means that a particular feature, structure, material, or characteristic described in connection with the embodiment is included in at least one embodiment of the invention. Thus, the appearances of phrases containing the term “embodiment(s)” in various places throughout this specification are not necessarily referring to the same embodiment of the invention. Furthermore, the particular features, structures, materials, or characteristics may be combined in any suitable manner in one or more embodiments.

In the present disclosure, “%” refers to “weight % (wt. %)” or “mass %”, unless otherwise stated.

As used herein, the phrase “consisting of excludes any element, step, or ingredient not specified in the claim. When the phrase “consists of (or variations thereof) appears in a clause of the body of a claim, rather than immediately following the preamble, it limits only the element set forth in that clause; other elements are not excluded from the claim as a whole. As used herein, the phrase “consisting essentially of limits the scope of a claim to the specified elements or method steps, plus those that do not materially affect the basis and novel characteristic(s) of the claimed subject matter.

When introducing elements of the embodiments described herein, the articles “a”, “an”, “the” and “said” are intended to mean that there are one or more of the elements.

The terms “comprises”, “comprising”, or any other variations thereof used in the disclosure, are intended to cover a non-exclusive inclusion, such that a device, apparatus, system, assembly, method that comprises a list of components or a series of steps that does not include only those components or steps but may include other components or steps not expressly listed or inherent to such apparatus, or assembly, or device. In other words, one or more elements or steps in a system or device or process proceeded by “comprises . . . a” or “comprising . . . of does not, without more constraints, preclude the existence of other elements or additional elements or additional steps in the system, device, or process as the case may be. Besides, the use of “comprising”, “consisting” or “including” also contemplates embodiments that “consist essentially of or “consist of the recited formulation and steps of preparation of the formulation.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range, or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

In this disclosure, the terms “including,” “containing,” and/or “having” are understood to mean comprising and are open ended terms.

As various changes could be made in the above-described methods without departing from the scope of the invention, it is intended that all matter contained in the above description and in the examples given below, shall be interpreted as illustrative and not in a limiting sense.

### EXAMPLES

While the present invention is disclosed in reference to the preferred embodiments or examples above, it is to be understood that these embodiments or examples are intended for illustrative purposes, which shall not be treated as limitations to the present invention. It is contemplated that modifications and combinations will readily occur to those skilled in the art, which modifications and combinations will be within the spirit of the invention and the scope of the following claims.

The following materials were sourced in the Examples noted below: Poketone M330F and Poketone M630F were sourced from Hyosung Chemical Corporation and used directly. Vistamaxx 6202 was used from Exxon Mobil and used directly. Vertex 90SA was sourced from Huber Materials and used directly.

The specific materials used are: Vertex 90SA: magnesium hydroxide, amino silane treated, 1.5 micron average particle size; Poketone M330 F, 60 g/10 min (240° C., 2.16 Kg) melt flow rate, aliphatic polyketone (“low molecular weight, easy to process”); Poketone M630 F, 6 g/10 min (240° C., 2.16 kg) melt flow rate, aliphatic polyketone, considered “high weight”, N, N′-molecular Struktol EBS, Ethylenebis(stearamide), CAS #110-30-5; Irganox 1010, Pentaerythritol tetrakis(3-(3,5-di-tert-butyl-4-hydroxyphenyl)propionate), CAS #6683-19-8; HIVAL PE LLD 102024, 20 g/10 min (190° C., 2.16 Kg) melt flow rate, 0.92 g/cm³ density; LARIPUR 5725, 55 shore D ester, Thermoplastic polyurethane; and Ultramid B27, 25 rV polyamide 6.

### Example 1: Screening Experiments

Higher molecular weight (Mw) polymers possess more desirable performance properties (mechanical strength, impact resistance, wear resistance etc) compared to lower Mw polymer. Further, adding fillers to polymers, such as Mg(OH)₂, is known to increase the melt viscosity of the polymer blend. Poketone M630 F is significantly higher in Mw than M330 F and therefore possesses higher performance.

The initial compositions prepared and evaluated are shown in Tables 1A and 1B. The initial experiments were conducted to determine the mechanical properties of the compositions. Magnesium hydroxide (Vertex 90SA) of 20 wt. % and 35 wt. % were studied in combination with blends of Poketone M330F, Poketone M630F, and Vistamaxx 6202. The basis for the experimental design was that 20% by weight Mg(OH)₂ blends with only M630 F, would be too viscous for commercial injection molding processing. Incorporating some weight percent M330 would help reduce melt viscosity.

Table 1 shows that the properties of compositions made in trail 3, 6, and 7 (compositions C, E, and G) show that Vistamaxx 6202 did not add any benefit to mechanical results and seemed to reduce the flame resistance or self extinguishing character. No further tests were made with Vistamaxx.

As shown in Table 2, materials assigned a ‘V’ rating, using UL classifications, are deemed to be self extinguishing. A V-1 rating is assigned to materials that self extinguish in 30 seconds or less and which do not drip flaming particles. For reference, as shown in the Table 2, the following ranking progresses from lowest level of self extinguishing performance to highest level: V-2<V-1<V-0<5VB<5VA. An HB rated material is one which is not self extinguishing.

Trial 2 (composition D) in Table 1A, is a composition containing only 20 wt. % Mg(OH)₂ and a blend of M630 F with M330 F (75:25 on resin) was rated as V-1, per UL94 guidelines (Table 1B). Notably, a 60 melt flow polyketone polymer and 20 wt. % Mg(OH)₂ yields a V-2 flame rating. Compositions from trial 2 (composition D) were re-molded and re-tested, and none burned for greater than 30 seconds, confirming the V-1 rating. The same trial 2 (composition D) composition was replicated 2 more times, in different run sizes. V-1 flame performance was confirmed on each replicate.

Subsequently, a 1500 lb. batch of trial 2 (composition D) was produced and preliminary assessment for suitability as a molding resin in was performed as described in Example 2 below.

TABLE 1A
Initial compositions

| Composition | A | B | C | D | E | F | G |
|---|---|---|---|---|---|---|---|
| Trial # | 4 | 1 | 3 | 2 | 6 | 5 | 7 |
| Lot# | A-22098-4 | A-22098-4 | A-22098-3 | A-22098-2 | A-22098-6 | A-22098-5 | A-22098-7 |
| Test | M330 | M330/M630 | M330/M630 | M330/M630 | M330/M630 | M330 | M330/M630 |
| | 20% | 50:50 | 50:50 | 25:75 | 25:75 | 35% | 25:75 |
| | Vertex | 20% Vertex | 20% Vertex | 20% Vertex | 20% Vertex | Vertex | 20% Vertex |
| | 90SA | 90SA | 90SA | 90SA | 90SA | 90SA | 90SA |
| | | | 8% Vmax | | 8% Vmax | | 8% Vmax |
| | | | 6202 | | 6202 | | 6202 |

TABLE 1B
Mechanical properties of initial compositions

| Composition | A | B | C | D | E | F | G |
|---|---|---|---|---|---|---|---|
| Trial # | 4 | 1 | 3 | 2 | 6 | 5 | 7 |
| Tensile Strength | 9,640 | 9,200 | 7,910 | 8,980 | 7,350 | 9,410 | 6,940 |
| (ASTM) psi | | | | | | | |
| Elongation at | 16.3 | 29.7 | 26.4 | 31.7 | 19.7 | 7.9 | 7.6 |
| Break (ASTM) % | | | | | | | |
| Modulus of | 371,000 | 376,000 | 325,000 | 370,000 | 296,000 | 520,000 | 394,000 |
| Elasticity | | | | | | | |
| (ASTM) psi | | | | | | | |
| Notched Izod | 1.19 | 1.70 | 1.64 | 1.86 | 1.95 | 1.14 | 1.25 |
| Impact Test | | | | | | | |
| ft-lb/in | | | | | | | |
| Specific gravity | | | | 1.37 | | | 1.42 |
| Ash Content % | 19.28 | 18.8 | 19.3 | 20.1 | 20.24 | 33.6 | 36.43 |
| Lbs packed | 520 | 50 | 50 | 50 | 25 | 520 | 20 |
| | short | 3 had burn | Short burn | 3 of 5 | short | short burn | Short |
| | burn | time > 30 | time, all | had burn | burn | time, all | burn time |
| | time, all | sec, all | samples | time > 30 | time, all | samples | 2 of 5 |
| | samples | samples | dripped | sec, | samples | dipped | dripped |
| | dipped | dripped | | no | dipped | | |
| | | | | dripping | | | |
| Flame | V-2 | V-2 | V-2 | V-1 | V-2 | V-2 | V-2 |
| Performace, | | | | | | | |
| UL94 rating | | | | | | | |

TABLE 2
UL Rating Table

| | Orientation | | Time | | | |
|---|---|---|---|---|---|---|
| | of | | of | Particle Drop Allowed | | |
| | Test | | Burn | | Non- | Plaque |
| Class | Sample | Definition | Allowed | Flaming | Flaming | Holes |
| UL 94 HB | Horizontal | Slow | Burning rate of less than 76 mm/min for a | | | |
| | | Burning | specimen less than 3 mm thick and burning | | | |
| | | | stops before 100 mm | | | |
| UL 94 V-2 | Vertical | Burning | 30 | Yes | Yes | |
| | | Stops | seconds | | | |
| UL 94 V-1 | Vertical | Burning | 30 | No | Yes | |
| | | Stops | seconds | | | |
| UL 94 V-0 | Vertical | Burning | 10 | No | Yes | |
| | | Stops | seconds | | | |
| UL 94 5VB | Vertical | Burning | 60 | No | No | Yes |
| | | Stops | seconds | | | |
| UL 94 5VA | Vertical | Burning | 60 | No | No | No |
| | | Stops | seconds | | | |

### Example 2: Enhanced Compositions

Table 3A describes the compositions and Table 3B describes test results obtained. Table 3A shows the weight % of the materials used. Mechanical data from these test runs is also shown in Table 3B.

The designations in Table 3A include a 4-digit number, for example 0100 or 1585 or 2575. These 4-digit numbers describe the ratio of Poketone M330F to Poketone M630F, on a resin/resin basis. Therefore, the designation 0100 indicates 0% Poketone M330F and 100% Poketone M630F and the designation 2575 indicates 25% M330F and 75% M630F, totaling: 100%. In the designation 2575 composition that contains 18% Mg(OH)₂ and 82% polyketone resin, 75% of the 82% polymer is Poketone M630 or 61.5% by weight and 25% of the 82% total polymer is Poketone M330F or 20.5% by weight. The seven (7) test runs using composition H-N shown in Table 3A were 25 lb each.

Composition M (test 6) in Tables 3A and 3B demonstrates that 15 wt. % magnesium hydroxide in a blend of 6 melt M630 F POK and M330 F resins delivers V-1 self-extinguishing flame resistance. Magnesium hydroxide levels at or below 12% by weight proved to be insufficient to impart self-extinguishing flame resistance. Prior art disclosed 15% magnesium hydroxide in 100%55 melt resin (comparable to M330 F) needed to achieve V-2 self-extinguishing flame resistance. By definition a V-2 rated material drips flaming particles which ignite a cotton swatch positioned below the test bar and which the test bar self-extinguishes in 30 seconds or less. In contrast, a V-1 rated material self-extinguishes in 30 seconds or less and does not drip flaming particles. It was not expected that using predominantly M630 F 6 melt flow resin would alter the ‘V’ flame performance and cause the test sample not to drip flaming particles. Increasing the apparent melt viscosity of the blend is likely why dripping was not observed. A non-dripping self-extinguishing composition offers enhanced fire safety by not promulgating the distribution of flaming particles.

TABLE 3A
Improved compositions based on composition D/trial 2 in Table 1. and
mechanical properties of the compositions

| Composition | H | I | J | K | L | M | N |
|---|---|---|---|---|---|---|---|
| | -NA-1008 | -NA-1010 | -NA-1012 | -NA-1012 | -NA-1015 | -NA-1015 | -NA-1018 |
| | POK 9000- | POK 9000- | POK 9000- | POK 9000- | POK 9000- | POK 9000- | POK 9000- |
| | 0100 | 0100 | 0100 | 01090 | 0100 | 1585 | 2575 |
| Test | 1 | 2 | 3 | 4 | 5 | 6 | 7 |
| M630F | 92 | 90 | 88 | 79.2 | 85 | 72.25 | 61.5 |
| Vertex 90SA | 8 | 10 | 12 | 12 | 15 | 15 | 18 |
| M330F | | | | 8.8 | | 12.75 | 20.5 |
| 330/360 Ratio | 0 | 0 | 0 | 0.1 | 0 | 0.15 | 0.25 |
| Total | 100 | 100 | 100 | 100 | 100 | 100 | 100 |

TABLE 3B
Mechanical properties of the compositions in Table 3A.

| Composition | H | I | J | K | L | M | N |
|---|---|---|---|---|---|---|---|
| Test | 1 | 2 | 3 | 4 | 5 | 6 | 7 |
| Tensile | 9630 | 9570 | 9450 | 9490 | 9300 | 9450 | 9670 |
| Strength | 66.4 | 66.0 | 65.2 | 65.4 | 64.1 | 65.2 | 66.7 |
| (ASTM) psi/ | | | | | | | |
| MPa | | | | | | | |
| Elongation at | 47.2 | 33.1 | 37.1 | 35.1 | 31.5 | 33.2 | 28.2 |
| Break (ASTM) | | | | | | | |
| % | | | | | | | |
| Tensile | 367000 | 367000 | 360000 | 370000 | 361000 | 367000 | 408000 |
| Modulus psi | 2.53 | 2.53 | 2.48 | 2.55 | 2.49 | 2.53 | 2.81 |
| GPa | | | | | | | |
| Notched Izod | 1.76 | 1.74 | 1.77 | 1.68 | 1.75 | 1.64 | 1.48 |
| KJ/m² | 9.4 | 9.3 | 9.4 | 9.0 | 9.3 | 8.8 | 7.9 |
| Specific | 1.29 | 1.30 | 1.31 | 1.31 | 1.33 | 1.33 | 1.35 |
| gravity | | | | | | | |
| Ash Content | 7.4 | 9.3 | 11.1 | 11.9 | 15.2 | 15.3 | 17.8 |
| % | | | | | | | |
| UL-94 3 mm, | BTC | BTC | BTC | BTC | V-1 | V-1 | V-1 |
| BTC = burned | | | | | | | |
| to the clamp | | | | | | | |

### Example 3: Enhanced Compositions O-W (N23)

A follow-on set of experiments was conducted to further explore the results in Table 3. Test blends (N23, compositions O-W) shown in Table 4A were made evaluating 14 wt. % magnesium hydroxide in M630 F along with an added 0.5% by weight Irganox 1010. Table 4B shows that M630 F 6 melt resin and 14 wt. % magnesium hydroxide was self-extinguishing (SE), but required 40-50 seconds. By UL criteria Test 9 (composition W) was rated NR because the burn time was greater than 30 seconds. However, Test 9 (composition W) did not drip flaming particles.

When ethylene bis stearamide (EBS), a process aid/lubricant, was included in the composition containing 14% magnesium hydroxide and M630 F, the material self-extinguished in 30 seconds or less, sample 8. The lubricant aided in lowering the melt temperature in the compounding extruder by more than 20 degrees Fahrenheit and it is postulated that this lower melt temperature allowed for the magnesium hydroxide to retain its water of hydration (which is essential for its mode of self-extinguishing a flame). Additional trials 1-7 were run, evaluating additional lubricants and process aids, and at different weight percent loadings, including blends with linear low-density PE (LLDPE) resulting in compositions O to W. Tests 1-8 (composition O-W), were all self-extinguishing, with 3, 4, 6, 7 and 8 also exhibiting non-dripping behavior (V-1 rating).

### Example 4: Enhanced Compositions X-AB (WT 23)

Various ratios of 6 melt and 60 melt polyketone were evaluated as shown in Table 5, where white pigment was added to assess the effect of colorant on self-extinguishing behavior. Test blends 3-5 were made at 14% magnesium hydroxide with 1% pigment, and various ratios of 6 and 60 melt polyketone and all were measured to self-extinguish at 30 seconds or less and none dripped, thereby were rated V-1. These results demonstrated a lack of interference in self-extinguishing performance when colorants are included.

### Example 5: Enhanced Compositions AC-AG (PB 23)

Test blends were made with Laripur 5725 thermoplastic polyurethane (TPU) and with Ultramid B27 polyamide 6 (PA6). Both of these polymers are known to be miscible with polyketone and impart interesting enhancements to toughness, heat resistance and flexibility. The data in Table 6 demonstrate that polymer blends of TPU or PA6 in polyketone likewise retain self-extinguishing properties.

TABLE 4A
Compositions O-W

| Composition | O | P | Q | R | S | T | U | V | W |
|---|---|---|---|---|---|---|---|---|---|
| Color: | Natural | Natural | Natural | Natural | Natural | Natural | Natural | Natural | Natural |
| Test | 1 | 2 | 3 | 4 | 5 | 6 | 7 | 8 | 9 |
| M630 | 0 | 39 | 57 | 69 | 61 | 61 | 83 | 85 | 85.5 |
| M330 | 77 | 38 | 20 | 10 | 20 | 22 | | | |
| Irganox 1010 | 0.5 | 0.5 | 0.5 | 0.5 | 0.5 | 0.5 | 0.5 | 0.5 | 0.5 |
| Vertex 90SA | 18 | 18 | 18 | 16 | 14 | 14 | 14 | 14 | 14 |
| HIVAL PE | 4 | 4 | 4 | 4 | 4 | 2 | 2 | | |
| LLD 102024 | | | | | | | | | |
| NAT | | | | | | | | | |
| EBS, Struktol | 0.5 | 0.5 | 0.5 | 0.5 | 0.5 | 0.5 | 0.5 | 0.5 | |
| Total | 100 | 100 | 100 | 100 | 100 | 100 | 100 | 100 | 100 |
| 330/630 ratio | 1.00 | 0.49 | 0.26 | 0.13 | 0.25 | 0.27 | 0.00 | 0.00 | 0.00 |

TABLE 4B
Mechanical properties of compositions O-W

| Composition | O | P | Q | R | S | T | U | V | W |
|---|---|---|---|---|---|---|---|---|---|
| Test | 1 | 2 | 3 | 4 | 5 | 6 | 7 | 8 | 9 |
| Flame Data | V-2 | V-2 | V-1 | V-1 | V-2 | V-1 | V-1 | V-1 | NR |
| Specific | 1.33 | 1.33 | 1.33 | 1.33 | 1.32 | 1.32 | 1.32 | 1.33 | 1.33 |
| gravity | | | | | | | | | |
| Tensile | 53 | 54 | 54.1 | 56 | 55 | 55 | 56.2 | 57.2 | 57 |
| Strength | | | | | | | | | |
| (MPa) | | | | | | | | | |
| Tensile | 53 | 54 | 54.1 | 56 | 55 | 55 | 56.2 | 57.2 | 57 |
| Elongation @ | | | | | | | | | |
| Break (%) | | | | | | | | | |
| Tensile | 1.98 | 1.98 | 1.98 | 1.92 | 1.89 | 1.89 | 1.87 | 1.87 | 1.87 |
| Modulus | | | | | | | | | |
| (GPa) | | | | | | | | | |
| Notched | 4.5 | 5 | 5.21 | 6.50 | 5.21 | 5.21 | 7.5 | 7.1 | 6.9 |
| Charpy | | | | | | | | | |
| (kJ/m²) | | | | | | | | | |

TABLE 5
Compositions X-AB and mechanical properties
of compositions X-AB

| Compositions | X | Y | Z | AA | AB |
|---|---|---|---|---|---|
| Color | White | White | White | White | White |
| Test | 1 | 2 | 3 | 4 | 5 |
| M630 | 57 | 69 | 61 | 70 | 82 |
| M330 | 21 | 11 | 21 | 12 | |
| Irganox 1010 | 0.5 | 0.5 | 0.5 | 0.5 | 0.5 |
| Vertex 90SA | 18 | 16 | 14 | 14 | 14 |
| HIVAL PE LLD | 2 | 2 | 2 | 2 | 2 |
| 102024 NAT | | | | | |
| EBS, Struktol | 0.5 | 0.5 | 0.5 | 0.5 | 0.5 |
| Total | 100 | 100 | 100 | 100 | 100 |
| 330/630 ratio | 0.27 | 0.14 | 0.26 | 0.15 | 0.00 |
| Flame Data | V-1 | V-1 | V-1 | V-1 | V-1 |
| Specific gravity | 1.34 | 1.34 | 1.33 | 1.33 | 1.33 |
| Tensile Strength (MPa) | 54 | 55.5 | 56 | 54 | 55 |
| Tensile Elongation @ | 27 | 29 | 28 | 27 | 27 |
| Break (%) | | | | | |
| Tensile Modulus (GPa) | 1.98 | 1.92 | 1.89 | 1.89 | 1.87 |
| Notched Charpy (kJ/m²) | 5.1 | 6.60 | 5.0 | 5.5 | 7.7 |

TABLE 6
Compositions AC-AG and mechanical properties of
compositions X-AB (PB23 blends)

| Compositions | AC | AD | AE | AF | AG |
|---|---|---|---|---|---|
| Color | Natural | Natural | Natural | Natural | Natural |
| Test | 1 | 2 | 3 | 4 | 5 |
| M630 | 51 | 51 | 76 | 36 | 34 |
| M330 | 20 | 10 | 0 | 37 | 34 |
| Irganox 1010 | 0.5 | 0.5 | 0.5 | 0.5 | 0.5 |
| Vertex 90SA | 14 | 14 | 14 | 14 | 14 |
| HIVAL PE LLD | 4 | 4 | 4 | 2 | 2 |
| 102024 NAT | | | | | |
| EBS, Struktol | 0.5 | 0.5 | 0.5 | 0.5 | 0.5 |
| Total | 100 | 100 | 100 | 100 | 100 |
| 330/630 ratio | 0.28 | 0.16 | 0.00 | 0.51 | 0.50 |
| Flame Data | V-2 | V-2 | V-1 | V-1 | V-1 |
| Specific gravity | 1.34 | 1.34 | 1.33 | 1.33 | 1.33 |
| Tensile Strength (MPa) | 54 | 55.5 | 56 | 54 | 55 |
| Tensile Elongation @ | 27 | 29 | 28 | 27 | 27 |
| Break (%) | | | | | |
| Tensile Modulus (GPa) | 1.98 | 1.92 | 1.89 | 1.89 | 1.87 |
| Notched Charpy (kJ/m²) | 5.1 | 5.6 | 5.0 | 5.5 | 7.7 |

TABLE 7A
Compositions AH-AO

| Composition | AH | AI | AJ | AK | AL | AM | AN | AO |
|---|---|---|---|---|---|---|---|---|
| Color: | Natural | Natural | Natural | Natural | Natural | Natural | Natural | Natural |
| Trial # FR POK | 723-1 | 723-2 | 723-3 | 723-4 | 723-7 | 723-8 | 723-11 | 723-12 |
| M630 | 60.7 | 61.2 | 56.7 | 57.075 | 45.9 | 45.9 | 83 | |
| M330 | 20.3 | 20.8 | 19.3 | 19.425 | 30.6 | 30.6 | 30.6 | 80 |
| LVNA HS package | 1 | 0 | 1 | 1 | 1 | 1 | 1 | 1 |
| Vertex 90SA | 18 | 18 | 18 | 18 | 18 | 18 | 14 | 14 |
| HIVAL PE LLD | | | 5 | 4 | 4 | 4 | 2 | |
| 102024 NAT | | | | | | | | |
| 27 rV PA6 | | | | | | | | 5 |
| EBS, Struktol | | | | 0.5 | 0.5 | | | |
| Erucamide, TR- | | | | | | 0.5 | | |
| 131- Struktol | | | | | | | | |
| Total | 100 | 100 | 100 | 100 | 100 | 100 | 100 | 100 |
| 330/630 ratio | 0.25 | 0.25 | 0.25 | 0.25 | 0.4 | 0.4 | 0.00 | 1.00 |

TABLE 7B
Mechanical properties of compositions AH-AO

| Composition | AH | AI | AJ | AK | AL | AM | AN | AO |
|---|---|---|---|---|---|---|---|---|
| Melt Temp (F) | 449 | 455 | 460 | 421 | 452 | 450 | 475 | 434 |
| Flame Data | V-1 | V-1 | V-2 | V-1 | V-1 | V-1 | V-2 | V-1 |
| T1 (5 tests) | 10 | 4 | 15 | 32 | 15 | 10 | 13 | 33 |
| T2 (5 tests) | 68 | 68 | 108 | 63 | 69 | 93 | 116 | 59 |
| T2 + T3 (ea test < 60 sec) | 78 | 72 | 123 | 95 | 84 | 103 | 103 | 92 |
| T2 + T3 (ea test < 250 sec) | 78 | 72 | 123 | 95 | 84 | 103 | 129 | 92 |
| Dripping Y/N | N | N | N | N | N | N | N | N |
| Notes | | | *T2 60 | | | | | |
| | | | sec | | | | | |
| Specific Gravity | 1.35 | 1.35 | 1.33 | 1.33 | 1.33 | 1.34 | 1.32 | 1.32 |
| Tensile Strength (MPa) | 61.2 | 61.2 | 52.8 | 54.1 | 55 | 54.3 | 56.2 | 62.4 |
| Tensile Elongation @ | 23.4 | 26 | 25.9 | 27 | 25.3 | 28.5 | 29.7 | 22.9 |
| Break (%) | | | | | | | | |
| Tensile Modulus (GPa) | 2.16 | 2.13 | 1.95 | 1.98 | 2.03 | 2.08 | 1.87 | 2.13 |
| Notched Charpy (kJ/m²) | 5.9 | 6.59 | 6.44 | 5.21 | 4.77 | 6.05 | 8.25 | 4.62 |

What is claimed is:

1. A self-extinguishing aliphatic polyketone composition suitable for direct or indirect contact with food comprising: about 80.0 wt. % to about 95.0 wt. % of an aliphatic polyketone polymer resin and from about 5.0 wt. % to about 20.0 wt. % of an amino silane surface modified magnesium hydroxide.

2. The composition of claim 1, wherein the aliphatic polyketone polymer resin comprises from about 75.0 wt. % to about 100.0 wt. % of a high molecular weight aliphatic polyketone polymer resin and about 0.0 wt. % to about 25.0 wt. % of a low molecular weight aliphatic polyketone resin.

3. The composition of claim 1, wherein the amino silane surface modified magnesium hydroxide comprises an average particle size of about 1.5 microns or less.

4. The composition of claim 1, wherein the composition comprises a V-2 flame performance by a plastic flammability standard.

5. The composition of claim 1, wherein the composition comprises a tensile strength ranging from about 9,200 pounds per square inch (psi) to about 9,700 psi.

6. The composition of claim 1, wherein the composition comprises an elongation at break ranging from about 33% to about 48%.

7. The composition of claim 1, wherein the composition comprises a tensile modulus ranging from about 360,000 psi to about 370,000 psi.

8. The composition of claim 1, wherein the composition comprises a notched Izod impact test ranging from about 1.60 ft-lb/in to 1.80 ft-lb/in.

9. The composition of claim 1, wherein the composition comprises a specific gravity ranging from about 1.28 to about 1.36.

10. The composition of claim 1, wherein the composition has an ash content ranging from about 7.0% to about 18.0% after the composition is heated to about 500° C. or greater to burn off the polyketone polymer from the composition.

11. The composition of claim 1, wherein the composition exhibits an inverse synergistic effect between a melt viscosity and a minimum amount of amino silane surface modified magnesium hydroxide magnesium hydroxide to provide the composition with a self-extinguishing performance.

12. A method of preparing a self-extinguishing aliphatic polyketone composition suitable for direct or indirect contact with food, the method comprising the steps of: combining an aliphatic polyketone polymer resin and an amino silane surface modified magnesium hydroxide to form a mixture; melting the mixture; and forming the self-extinguishing aliphatic polyketone composition.

13. The method of claim 12, wherein the aliphatic polyketone polymer resin comprises from about 60.0 wt. % to about 95.0 wt. % of a high molecular weight aliphatic polyketone polymer resin and about 5.0 wt. % to about 25.0 wt. % of a low molecular weight aliphatic polyketone resin.

14. The method of claim 12, wherein the amino silane surface modified magnesium hydroxide comprises an average particle size of about 1.5 microns.

15. The method of claim 12, wherein the composition comprises a V-2 flame performance by a plastic flammability standard.

16. The method of claim 12, wherein the composition comprises a tensile strength ranging from about 9,200 pounds per square inch (psi) to about 9,700 psi.

17. The method of claim 12, wherein the composition comprises an elongation at break ranges from about 33% to about 48%.

18. The method of claim 12, wherein the composition comprises a tensile modulus ranging from about 360,000 psi to about 370,000 psi.

19. The method of claim 12, wherein the composition comprises a notched Izod impact test ranging from about 1.60 ft-lb/in to 1.80 ft-lb/in.

20. The method of claim 12, wherein the composition comprises a specific gravity ranging from about 1.28 to about 1.36.

21. The method of claim 12, wherein the composition has an ash content ranging from about 7.0% to about 18.0% after the composition is heated to about 500° C. or greater to burn off the polyketone polymer from the composition.

22. The method of claim 12, wherein the method exhibits an inverse synergistic effect between the composition's melt viscosity and a minimum amount of magnesium hydroxide to provide the composition with a self-extinguishing performance.

23. A self-extinguishing aliphatic polyketone composition suitable for direct or indirect contact with food comprising: about 84.0 wt. % to about 86.9 wt. % of an aliphatic polyketone polymer resin, about 0.1 wt. % to about 1 wt. % an antioxidant, and from about 13.0 wt. % to about 15.0 wt. % of an amino silane surface modified magnesium hydroxide.

24. The self-extinguishing aliphatic polyketone composition of claim 23, wherein the composition further comprises one or more dispersing agents.

25. The self-extinguishing aliphatic polyketone composition of claim 24, wherein the composition further comprises one or more linear low density polyethylene polymers.

26. The self-extinguishing aliphatic polyketone composition of claim 25, wherein the composition further comprises from about 20.0 wt. % to about 24.0 wt. % of the aliphatic polyketone polymer resin.

27. The self-extinguishing aliphatic polyketone composition of claim 26, wherein the composition further comprises from about 0.5 wt. % to about 1.5 wt. % of one or more white pigments.

28. The self-extinguishing aliphatic polyketone composition of claim 27, wherein the composition further comprises one or more thermoplastic polyurethane polymers.

29. The self-extinguishing aliphatic polyketone composition of claim 27, wherein the composition further comprises one or more polyamide polymers.
